(19) United States
(12) Patent Application Publication
(10) Pub. No.: US 2015/0244459 A1
(43) Pub. Date: Aug. 27, 2015

(54) Vehicle to Vehicle Communication System

(71) Applicant: John Lindsay, Dallas, TX (US)

(72) Inventor: John Lindsay, Dallas, TX (US)

(21) Appl. No.: 14/710,553

(22) Filed: May 12, 2015

Related U.S. Application Data
(63) Continuation of application No. PCT/US2014/030086, filed on Mar. 15, 2014.
(60) Provisional application No. 61/792,148, filed on Mar. 15, 2013.
(60) Provisional application No. 61/825,068, filed on May 19, 2013.

(51) Int. Cl. H04B 10/112

(52) U.S. Cl. CPC H04B 10/1129; H04B 10/1123

(57) ABSTRACT

Exemplary embodiments of the present invention are directed to a vehicle to vehicle communication system for mounting to a vehicle including an emitter in communication with a receiver. The emitter includes an emf source configured to transmit a directional beam distal to the vehicle, wherein the beam is transmitted such that it has less than a pre-configured signal strength outside a configured width. The receiver is in communication with the emitter, the emitter configured to transmit the beam in response to signal input to the receiver from a distal vehicle to vehicle communication system.

### PRIORITY

The present invention claims priority to PCT patent application PCT/US2014/030086, which has a filing date of Mar. 15, 2014. PCT patent application PCT/US2014/030086 claims priority to provisional application 61/792,148, which has a filing date of Mar. 15, 2013. PCT patent application PCT/US2014/030086 claims priority to provisional application 61/825,068, which has a filing date of May 19, 2013.

### BACKGROUND

1. Field of the Invention

The present invention relates to a vehicular communication system, more specifically to a vehicle to vehicle communication system.

2. Description of the Related Art

For certain driving conditions, communications from one vehicle to a subset of other proximate vehicles is desirable. Two such example situations are a braking or turn signal usage. In such situations, alerting vehicles outside the signaling vehicle's lane of travel would result in false alerts to those other vehicles.

In a braking situation, reaction time is one of the most significant factors in causes of rear-end vehicular collisions. Driver reaction times are greatly affected by whether the driver is alerted to the need to brake. In a representative problem scenario illustrated in FIG. 5a, there is a leading vehicle 1, a first trailing vehicle 2, and a second trailing vehicle 3. When the leading vehicle 1 directly ahead of the first trailing vehicle 2 stops, the driver of the first trailing 2 vehicle is alert, visual conditions are excellent, and the driver notices the brake signal or turn signal of the leading vehicle 1, the best possible reaction time is achieved. However, where the second trailing vehicle 3 is further behind and obscured by the first trailing vehicle 2, the driver of that second trailing vehicle 3 is unable to see the braking or other signal lights of that leading vehicle 1. That driver must rely on the reaction time and driving style of the vehicles between him and the leading vehicle 1 and rely on the driver of the intervening first trailing vehicle 2 in order to maximize reaction time and apply the brakes at the earliest possible opportunity.

Even where there is no intervening vehicle, it may not be possible for the first trailing vehicle's 2 driver to see the signal lights of a vehicle directly in front of the driver under poor visual conditions such as fog or heavy rain.

In such cases, the driver loses valuable time needed to interpret the event, decide upon the response, and then apply brakes, steer, or other suitable response. To a great extent, available reaction time depends on the distance of the lead vehicle 1 to the trailing vehicles 2 3 when it activates its signal light. Differences in drivers' attention and reaction time in tenths of a second or lower can limit accidents and decrease high stress driving.

These problems are exaggerated in congestion zones or peak driving times, leading to frequent hard stopping, frequent acceleration, and a poor driving experience. Thus it would be desirable for a system which enables improved reaction times.

### SUMMARY

Exemplary embodiments of the present invention are directed to a vehicle to vehicle communication system for mounting to a vehicle comprising an emitter in communication with a receiver. The emitter includes an emf source configured to transmit a directional beam distal to the vehicle, wherein the beam is transmitted such that it has less than a pre-configured signal strength outside a configured width. The receiver is in communication with the emitter, with the emitter configured to transmit a beam in response to signal input to the receiver from a distal vehicle to vehicle communication system.

These and other features, aspects, and advantages of the invention will become better understood with reference to the following description, appended claims, and accompanying drawings.

### BRIEF DESCRIPTION OF THE DRAWINGS

FIG. 1 illustrates a top view of embodiments of the invention as it may exist in operation;

FIG. 2 illustrates a top view of an embodiment of the invention as it may exist in operation;

FIG. 3 illustrates a block diagram of the embodiment illustrated in FIG. 1; and

FIG. 4 illustrates an embodiment of a process implemented to the system of FIG. 1;

FIGS. 5a-5c illustrate side views of embodiments of the system as they may exist in operation; and

FIG. 6 illustrates traffic analysis module aggregate traffic data and suggested traffic instructions.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

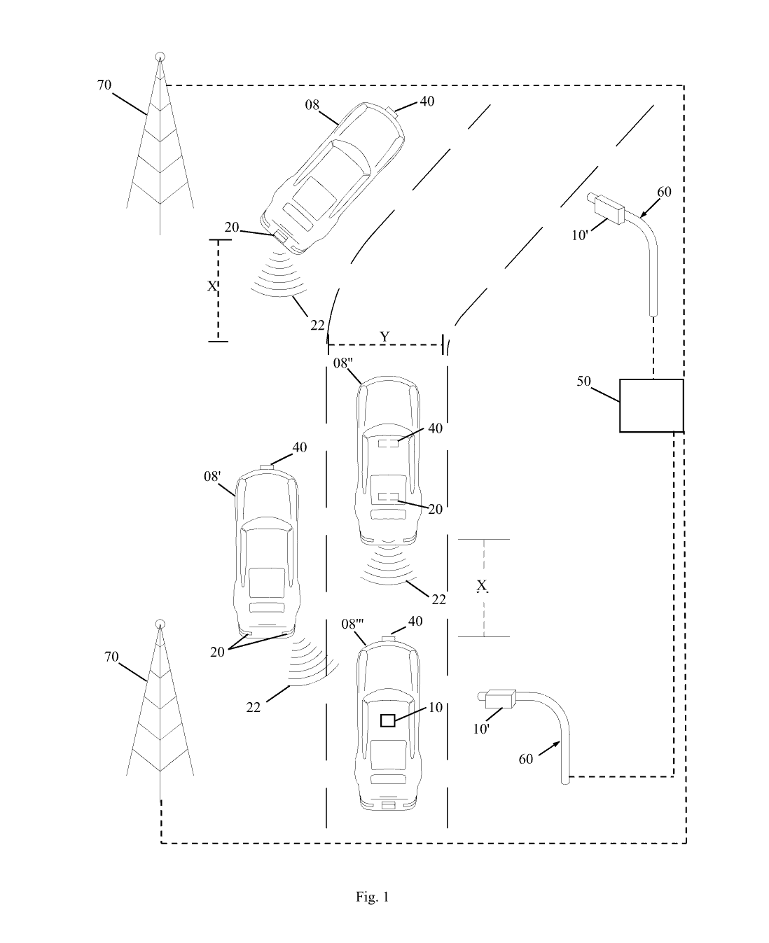

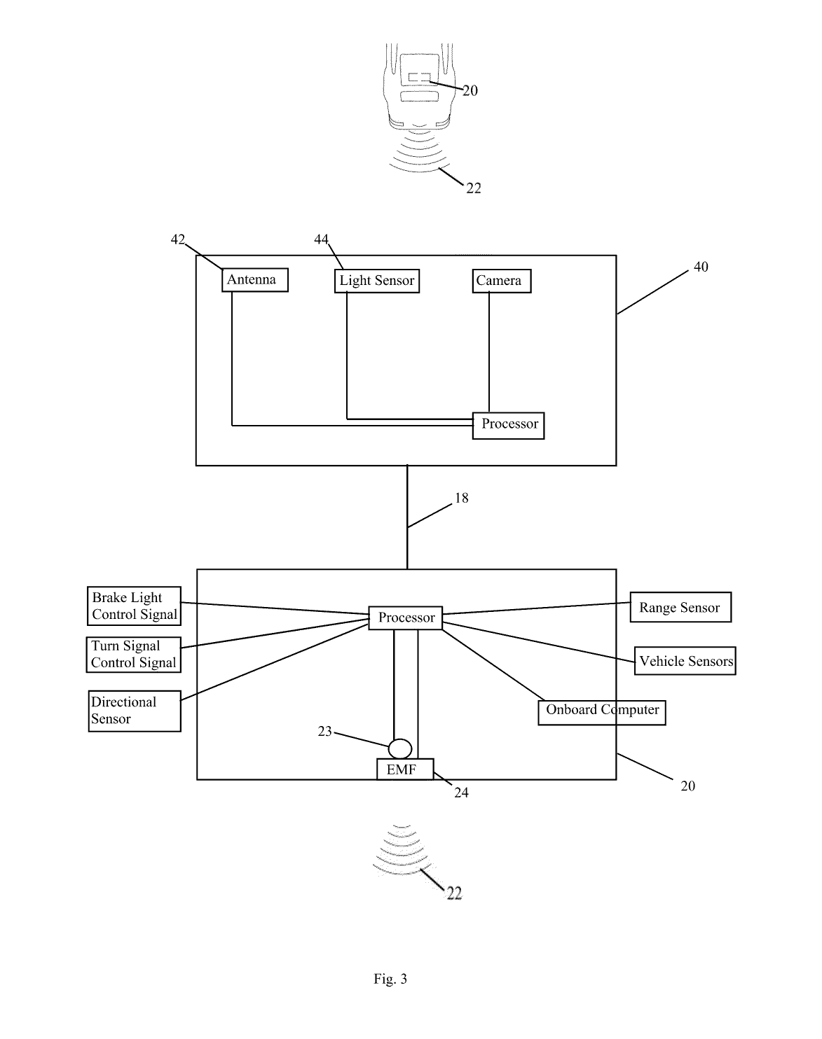

The current invention relates to a device for directed vehicle to vehicle communication. A representative scenario is relaying a vehicle's signal condition to trailing vehicles in the same lane. FIG. 1 illustrates a plurality of vehicles 08 equipped with vehicle to vehicle communication systems 10 (shown separately in FIG. 3) as they may exist in operation. The vehicle to vehicle communication system 10 includes an emitter 20 and a receiver 40 for attachment to a single vehicle 08. As shown, the emitter 20 and receiver 40 can be configured for different spatial placement on a vehicle 08. They can be housed in a single unit 08″' for attachment to the vehicle ceiling or roof. The system 10 can be configured for receiver 40 placement on the front of the vehicle 08 08′ or toward the front of the vehicle 08″. The vehicle to vehicle communication system 10 can be configured for emitter 20 placement on the rear of the vehicle 08 08′ or toward the rear of the vehicle 08″.

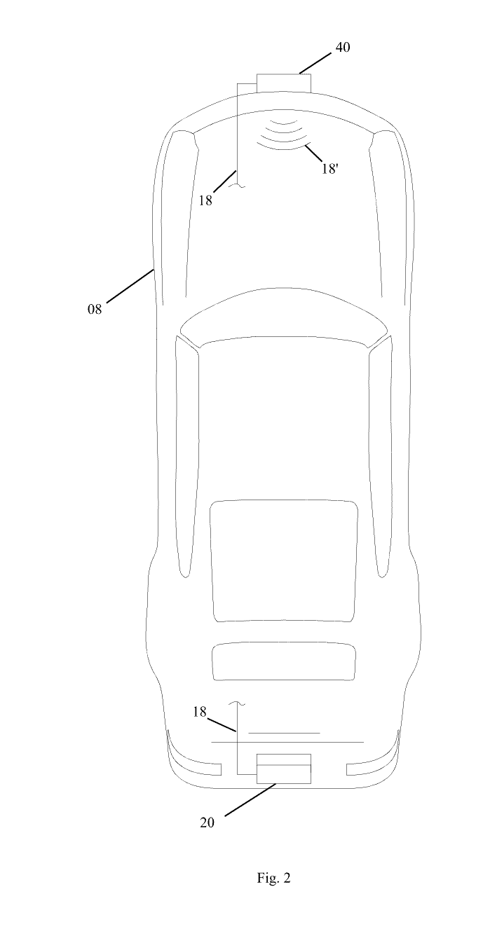

FIG. 2 illustrates an embodiment of the vehicle to vehicle communication system 10 deployed to a vehicle 08. Depicted is an emitter 20 in communication with a receiver 40. FIG. 3 illustrates a block diagram of the embodiment of FIG. 2. The emitter 20 is operable to signal in response to threshold signal input to the receiver 40 or a signal use condition of the subject vehicle. A signal use condition is one in which a signal light is in use or its use is warranted. Exemplary signal use conditions include brake signal use or turn signal use. For example, a switch may be mounted inline with the signal for the brake light or turn signal in the vehicle. In an automated driving system, a control signal for a brake light or turn signal activation can be monitored. Alternatively, the emitter 20 can employ sensors to detect the use condition. In such a configuration, the emitter 20 can include a light sensor mounted proximate the signal light of the vehicle 08. When a driver of the vehicle 08 depresses the brake pedal or uses the turn signal switch, the vehicle 08 activates the corresponding signal light. The emitter 20 detects the control signal or the light therefrom. Another example signal condition is a road hazard such as a pothole.

In one configuration, the emitter 20 includes a configured visual signal. The exemplary signal is one which is different than current brake signals. Representative visual signals include selected shapes, colors, brightness, flashing sequences, unique indicia, or the like.

In an alternate configuration, the emitter 20 contains an electromagnetic radiation source 24, configured to transmit a directional beam 22 from the vehicle 08. In one configuration, the electromagnetic radiation source 24 includes a coherent light source such as a laser. In an alternate configuration, the electromagnetic radiation source 24 includes a light source such as a filament or LED. In yet another configuration, the electromagnetic radiation source 24 includes a radio wave source.

In exemplary configuration, to the extent that the electromagnetic radiation source 24 permits, the beam 22 width is transmitted such that it has less than a configured signal strength outside a configured width y and less than a configured signal strength at a pre-configured distance x for a given set of environmental conditions. In exemplary operation, the beam 22 width is less than about one traffic lane wide at distance x or has a lower signal strength outside the configured width. Beam 22 width is controlled using processes known in the art. In certain configurations, a laser is included. In other configurations, an LED or filament coupled with a lens is is included. Radio frequency is controlled by using reflectors, antennae arrays, apertures, and/or specific wavelengths in order to control beam 22 width.

It is within the scope of this invention to vary the signal strength of the beam 22. For example, the signal strength can be altered in response to rain, fog, or other conditions which alter signal transmission. It is also within the scope of the invention to incorporate multiple electromagnetic radiation sources 24. In certain configurations, the emitter 20 energizes one or more of the electromagnetic radiation sources 24 during operation. For example, the emitter 20 can include both a light source and a radio frequency source and transmit radio frequency where light transmission may be suboptimal.

In exemplary configuration, to the extent that the electromagnetic radiation source 24 permits, the beam 22 width is configured to have configured signal strength or range of signal strength in order to have less than a configured signal strength at a pre-configured distance x for a given set of environmental conditions. For example, the beam 22 can be configured with a transmission strength such that the beam 22 signal strength is approximately zero or below a threshold signal strength at distance x. Alternatively, the beam 22 may be configured for transmission where the beam 22 signal strength is a known amount at distance x for given conditions. In certain configurations, the beam 22 transmission strength is adjusted based on input for environmental conditions which would affect transmission distance. For example, a humidity sensor can provide input for rain or fog conditions that could impede light or radio wave transmission.

Optionally, the emitter 20 is configured to direct the beam 22 in response to turning conditions of the vehicle. The emitter 20 can receive steering wheel use, position data, accelerometer, global positioning system (GPS) data, or other similar sensing to detect a turn condition. In response, the emitter 20 employs a beam director 23 to alter the beam 22 direction proportionate to the turn angle of the vehicle, as shown in vehicle 08. In an alternate configuration, the emitter 20 is deactivated during a turn condition.

In certain embodiments, the emitter 20 encodes data into the beam 22. One such data element that the beam 22 can incorporate is relay count data, which facilitates peer to peer, vehicle to vehicle network type communication. That is to say a “chain” of vehicles relay data as nodes. Relay count data facilitates configurable conditional signal transmission through the vehicular chain. A base relay count can be provided by the receiver 40, as will be disclosed below. Relayed data through the vehicular chain is variable. For example, a total relay count is the number of vehicles that have relayed a signal (ie a “hop count”). In such a situation, the emitter 20 can increment the received active relay count data prior to encoding for transmission to trailing vehicles. An active relay count is the instantaneous number of signal use conditions, such as activated vehicle signals, within range of one or more vehicle to vehicle communication systems 10 in the chain. In exemplary usage scenarios, active relay count is the number of vehicles in the same lane in front of the subject vehicle with activated vehicle signal lights, such as applying brakes or turn signals.

In certain configurations, other data is encoded in the beam 22, such as a car identifier, accelerometer data, velocity data, directional data, GPS data, lane indication data, other data from the subject vehicle, other vehicle(s) signal relay systems 10 data, or derived data can be encoded within the beam 22. The received data for encoding can include sources from the vehicle computer, sensors, portable computers of a vehicle occupant, or other vehicle to vehicle communication systems 10. For example, the beam 22 can incorporate inter-vehicle distance data, such as that between the leading vehicle and the subject vehicle from a range sensor system. Moreover, the vehicle to vehicle communication systems 10 can process the data prior to encoding. To illustrate, the emitter 20 can accumulate the distance data of leading vehicles and add distance between the subject vehicle and leading vehicle for encoding and transmission.

Referring to FIG. 3, the emitter 20 is in communication with the receiver 40 via a cable 18 or wirelessly 18′. In certain configurations, the receiver 40 is operable to monitor, receive, and decode beams of the emitters 20 of similarly configured vehicle to vehicle communication systems 10 of other vehicles. During monitoring, the receiver 40 monitors receipt of a beam 22 at an antenna 44 or light sensor 42. Upon receipt of a beam 22, the receiver 40 optionally determines signal strength. Where the signal strength of the beam 22 is lower than a pre-determined threshold, the receiver 40 may cease further signal or relay processing steps.

The receiver 40 decodes the data of the beam 22 of a leading vehicle, including the relay count and other data. The decoded data is stored for retrieval and use by the emitter 20, the notification system of the vehicle 08, vehicle computer, or other systems. In one configuration, the receiver 40 signals the notification system of the vehicle 08, where the notification system activates a signal to alert the driver of the subject vehicle via a dash indicator or window display, optionally signaling the active relay count. In yet another configuration, the receiver 40 conditionally transmits a notification or beam data when the relay count is less than a pre-configured threshold. In another configuration, the receiver 40 transmits the decoded data to a display or vehicle computer. In yet another configuration, the receiver 40, outputs a control signal for an automated vehicle control system input. In another configuration, the receiver 40 communicates the active relay count and other data to the emitter 20, optionally incrementing the relay count. When beam 22 transmission and receipt terminates or is below the threshold, receiver 40 post-beam processing activity terminates. The receiver 40 then can indicate a non-signal or below threshold state.

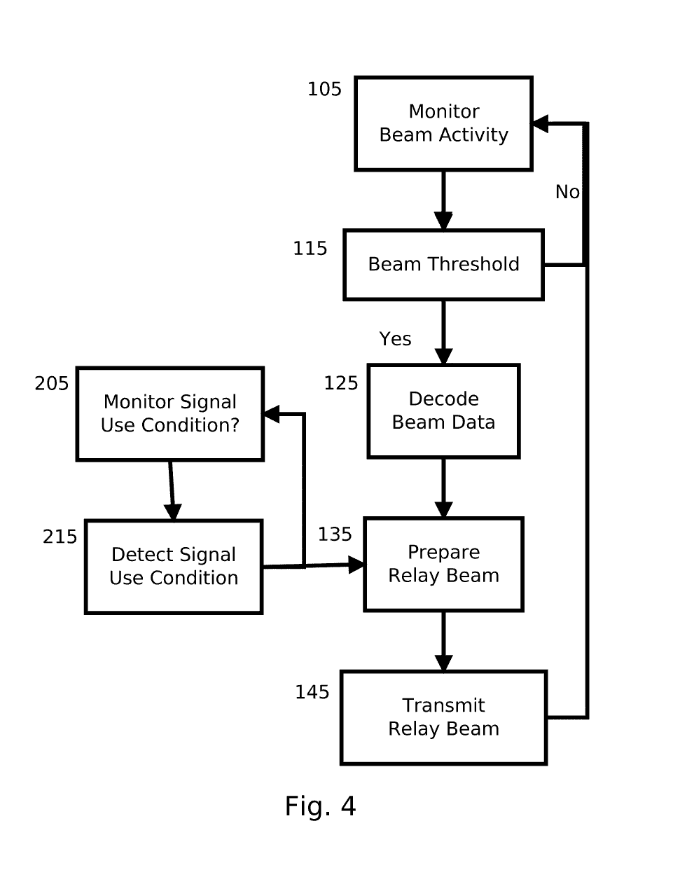

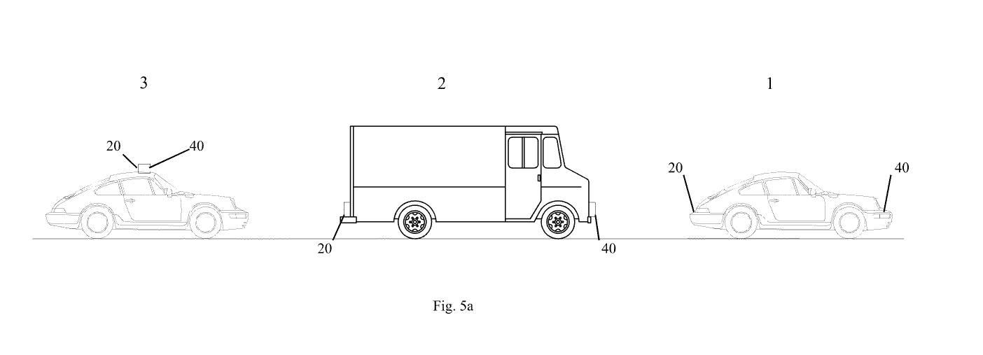

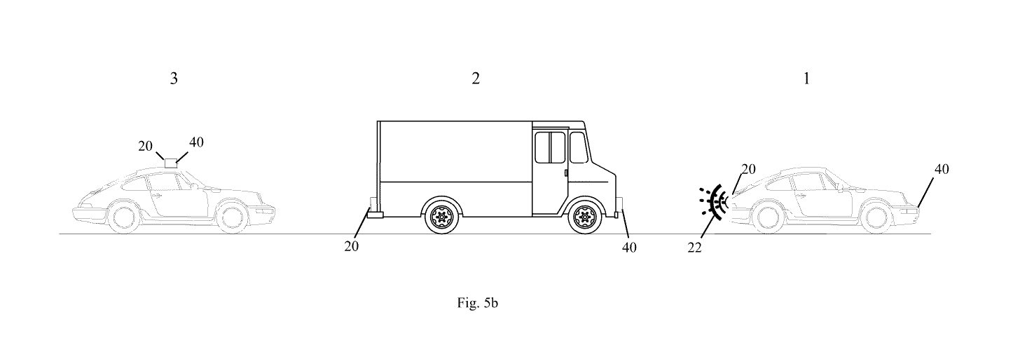

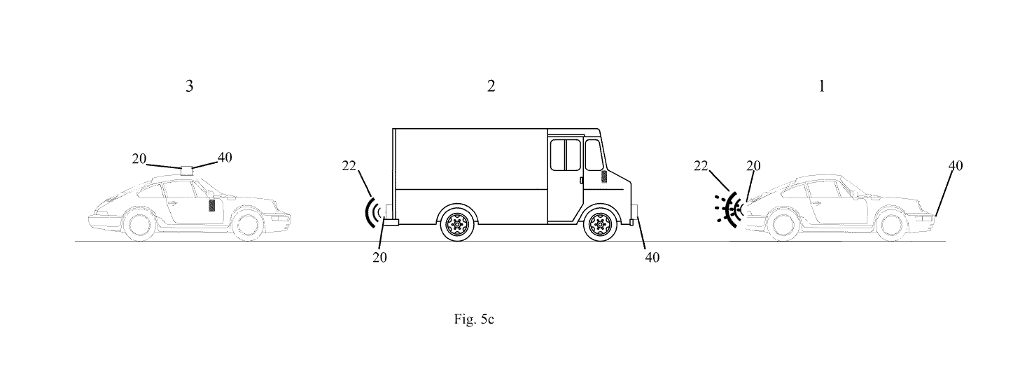

Having described elements of the vehicle to vehicle communication system 10, representative methods of operation are disclosed. FIG. 5a depicts a leading vehicle 1, a first trailing vehicle 2, and a second trailing vehicle 3, driving in a lane in sequence and each equipped with a vehicle to vehicle communication system 10. FIG. 4 depicts a process of an embodiment of the vehicle to vehicle communication system 10 in operation.

A leading vehicle's 1 vehicle to vehicle communication system 10 monitors for a signal use condition of the vehicle 1 205. Upon detection of a signal use condition 215, the vehicle to vehicle communication system 10 prepares a beam and transmits a beam for transmission 135 145. FIG. 5b illustrates the leading vehicle 1 with an activated brake signal and a simultaneous beam 22 of pre-configured width and signal strength. Below is the state of leading vehicle 1 in a braking signal use condition and its vehicle to vehicle communication system 10.

| | | | | Active | Leading |
|---|---|---|---|---|---|
| Signal Use | Signal | Beam | Total Relay | Relay | Vehicle |
| Condition | Activated? | Activated? | Count | Count | Signaling? |
| True | Brake | True | 0 | 0 | n/a |

The receiver 40 of first trailing vehicle 2 monitors for beam 22 activity from leading vehicles 1 equipped with similarly configured vehicle to vehicle communication systems 105. As described above, a signal use condition of a brake light and beam 22 of pre-configured width and signal strength is activated from the leading vehicle 1. Beam 22 is received by the first trailing vehicle 2 and the receiver 40 determines whether the beam 22 signal strength threshold is reached 115. If the beam 22 signal strength threshold is reached, the beam 22 data is decoded, displayed, and/or communicated to the emitter 125. In one configuration, the emitter 20 of the subject vehicle 2 activates its visual signal in response. The emitter 20 prepares beam data 135, retrieving and processing the necessary data. It increments the total relay count, conditionally incrementing active relay count with input from the receiver 205 215, retrieves the car identifier, and appends other data for encoding. The encoded beam 22 is transmitted 145. As illustrated in FIG. 5c, notifications of the brake light signal use condition of the leading vehicle 1 is shown in the trailing vehicles 2 3. Below is the state of first trailing vehicle 2 and its vehicle to vehicle communication system 10.

| | | | | Active | Leading |
|---|---|---|---|---|---|
| Signal Use | Signal | Beam | Total Relay | Relay | Vehicle |
| Condition | Activated? | Activated? | Count | Count | Signaling? |
| False | False | True | 1 | 1 | True |

The receiver 40 of second trailing vehicle 2 monitors for beam 22 activity from leading vehicles, in this scenario vehicle 2, equipped with similarly configured vehicle to vehicle communication systems 105. As described above, a signal use condition of a brake light and beam 22 of pre-configured width and signal strength is activated from the leading vehicle 1 and first trailing vehicle 2 transmits a relay signal 22 of the leading vehicle 1 signal use condition. Beam 22 is received by the second trailing vehicle 3 and the receiver 40 determines whether the beam 22 signal strength threshold is reached 115. The beam 22 data is decoded, displayed, and/or communicated to the emitter 125. In this scenario, the vehicle to vehicle communication system 10 is configured to only transmit relay beams 22 where the total relay count is less than or equal to one, thus it does not prepare beam data or transmit a beam 22. Below is the state of second trailing vehicle 3 and its vehicle to vehicle communication system 10.

| | | | | Active | Leading |
|---|---|---|---|---|---|
| Signal Use | Signal | Beam | Total Relay | Relay | Vehicle |
| Condition | Activated? | Activated? | Count | Count | Signaling? |
| False | False | False | 2 | 1 | True |

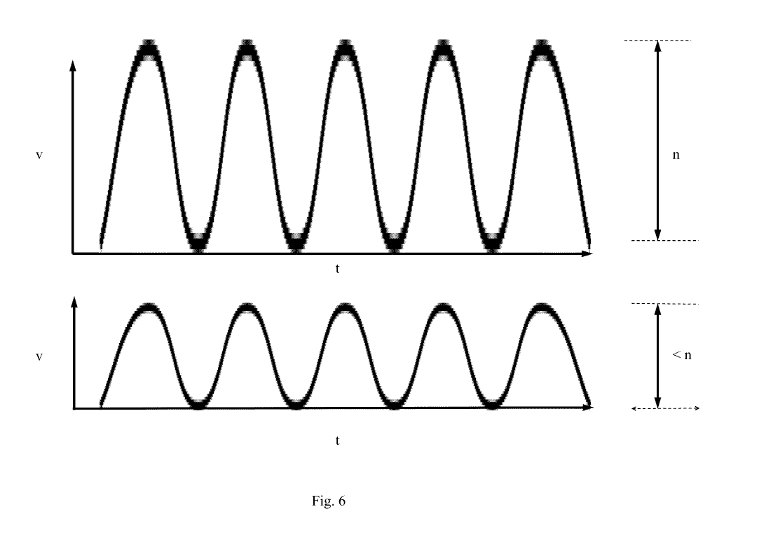

Now referring to FIGS. 1 and 6, in an alternate embodiment, the invention further includes a traffic analysis module 50 for traffic analysis of a plurality of vehicles 08 equipped with vehicle to vehicle communication systems 10 in a traffic zone. In exemplary operation, the traffic analysis module 50 conditionally transmits instructions in response to the traffic analysis. The traffic analysis module 50 includes a processor and memory. The traffic analysis module 50 defines one or more traffic zones to be monitored, a zone through which a plurality of vehicles 10 equipped with vehicle to vehicle communication systems 10 may pass. The traffic analysis module 50 receives beam 22 data from the vehicle to vehicle communication systems 10 of the vehicles or other sources. It should be appreciated that this communication may be in-band or out-of-band with the beam data 22 communications disclosed above. The traffic analysis module 50 associates position data with a particular vehicle 08 in order to confirm presence in the traffic zone. Optionally, the traffic analysis module 50 determines a position or relative position of a particular vehicle within the traffic zone.

Referring to FIG. 1, in one configuration, the traffic analysis module is in communication with at least one tower 60, and in exemplary configuration, a plurality of towers 60 in communication with each other and disposed at known locations within and adjacent the traffic zone. The exemplary tower 60 includes a traffic module receiver 40′ and traffic module emitter 20′ similar to those disclosed above. The receiver 40′ and emitter 20′ are preferably mounted above the vehicle heights for improved beam 22 reception by line of sight to plural vehicles. Optional configurations of the signal use emitter 20′ include widened beam 22 width and increased signal transmission strength for multi-vehicle transmissions. In alternate configurations, the position data of a particular vehicle to vehicle communication system 10 is based on an associated GPS, an associated portable computer, an associated portable phone and cell phone tower 70, or similar systems.

The traffic analysis module 50 processes received vehicular signal system 10 data for suboptimal traffic conditions, such as frequent sharp velocity changes or frequent signal use conditions. The module 50 may receive beam 22 data of a single vehicle 08, a sample of vehicles 08, or larger data set(s) of vehicles 08 within the traffic zone for analysis. In one configuration, the traffic analysis module 50 processes the velocity of the vehicles in the traffic zone and calculates peak to trough variations n over time, a representation of which is shown in the upper graph of FIG. 6. In an alternate configuration, the traffic analysis module 50 processes the number of active signal conditions over time. To illustrate, the module 50 may use the number of active brake lights per second within the traffic zone.

The traffic analysis module 50 optionally determines suggested instructions for optimizing traffic within the traffic zone, vehicles at the perimeter of the traffic zone, vehicles just adjacent and entering the traffic zone, or traffic control signals in or adjacent the traffic zone. The instructions correlate to the method employed to determine the suboptimal traffic condition. For example, in the disclosed peak to trough velocity analysis, the traffic analysis module may send suggested deceleration signals in order to decrease the peak to trough velocity and “flatten the curve,” as shown in the bottom graph of FIG. 6. In the disclosed simultaneous active signal process, the module 50 can also suggest deceleration signals. The method of communicating the suggested instructions varies. Representative methods includes a visual signal proximate the tower 60, a signal from the emitter 40′ of the tower 60 to subject vehicles, a message to a portable computer associated with the vehicle, a message from the cell phone tower 70 to a phone associated with the vehicle, or the like.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A system for vehicle to vehicle communication, said system comprising:
an emitter and receiver adapted for attachment to a vehicle;
said emitter having an emf source configured to transmit a directional beam distal to said vehicle, wherein said beam is transmitted such that it has less than a pre-configured signal strength outside a configured width; and
said receiver in communication with said emitter, said emitter configured to transmit said beam in response to signal input to said receiver from a distal vehicle to vehicle communication system.

2. The system of claim 1, wherein said emf source comprises a laser.

3. The system of claim 1, wherein said emf source comprises a light source transmitted through a lens.

4. The system of claim 1, wherein said emitter transmits said beam with a signal strength such that it has less than a pre-configured signal strength outside a pre-configured distance.

5. The system of claim 1, wherein said emitter is configured to receive vehicle direction information and is in communication with a beam director, said beam director altering the beam direction proportionally in response to received vehicle direction information.

6. The system of claim 1, wherein said emitter is configured to encode data in said beam, said data selected from at least one of the following: vehicle identifier, vehicle velocity, inter-vehicle distance, vehicle position, and vehicle direction.

7. The system of claim 1, wherein said emitter is configured to encode data in said beam, said data selected from at least one of the following: total relay count and active relay count.

8. The system of claim 1, wherein said emitter is configured to conditionally transmit said beam based upon received and decoded threshold relay count values.

9. A system for vehicle to vehicle communication, said system comprising:
an emitter and receiver adapted for attachment to a vehicle;
said emitter having an emf source configured to transmit a directional beam distal to said vehicle, wherein said beam is transmitted such that it has less than a pre-configured signal strength outside a configured width; and
said emitter configured to transmit said beam in response to a signal condition of said vehicle.

10. The system of claim 9 wherein said signal condition is selected from the following: a brake signal condition and a turn signal condition.

11. The system of claim 9, wherein said emf source comprises a laser.

12. The system of claim 9, wherein said emf source comprises a light source transmitted through a lens.

13. The system of claim 9, wherein said emitter transmits said beam with a signal strength such that it has less than a pre-configured signal strength outside a pre-configured distance.

14. The system of claim 9, wherein said emitter is configured to receive vehicle direction information and is in communication with a beam director, said beam director altering the beam direction proportionally in response to received vehicle direction information.

15. The system of claim 9, wherein said emitter is configured to encode data in said beam, said data selected from at least one of the following: vehicle identifier, vehicle velocity, inter-vehicle distance, vehicle position, and vehicle direction.

16. The system of claim 9, wherein said emitter is configured to encode data in said beam, said data selected from at least one of the following: total relay count and active relay count.

17. The system of claim 9, wherein said emitter is configured to conditionally transmit said beam based upon received and decoded threshold relay count values.

18. A system for vehicle to vehicle communication, said system comprising:
an emitter and receiver adapted for attachment to a vehicle;
said emitter having an emf source configured to transmit a directional beam distal to said vehicle, wherein said beam is transmitted such that it has less than a pre-configured signal strength outside a configured width;
said receiver in communication with said emitter, said emitter configured to transmit said beam in response to signal input to said receiver from a distal vehicle to vehicle communication system; and
said emitter configured to transmit said beam in response to a signal condition of said vehicle.

19. The system of claim 18, wherein said emf source comprises a light source.

20. The system of claim 18, wherein said emitter is configured to encode data in said beam, said data selected from at least one of the following: total relay count and active relay count; and
said emitter is configured to conditionally transmit said beam based upon received threshold relay count values.
